(19) United States
(12) Patent Application Publication
(10) Pub. No.: US 2026/0163033 A1
(43) Pub. Date: Jun. 11, 2026

(54) FUEL SUPPLY SYSTEM FOR FUEL CELL SYSTEM AND METHOD OF CONTROLLING THE SAME

(71) Applicants: Hyundai Motor Company, Seoul (KR); Kia Corporation, Seoul (KR)

(72) Inventor: Dong Seok KO, Hwaseong-Si (KR)

(21) Appl. No.: 19/219,329

(22) Filed: May 27, 2025

(30) Foreign Application Priority Data
Dec. 8, 2024 (KR) 10-2024-0137125

(51) Int. Cl. H01M 8/04746; H01M 8/04111; H01M 8/0438; H01M 8/04701

(52) U.S. Cl. CPC H01M 8/04753; H01M 8/04111; H01M 8/04388; H01M 8/04395; H01M 8/04708

(57) ABSTRACT

An apparatus may comprise a hydrogen compressor configured to compress a boil-off gas (BOG) from a liquid hydrogen storage tank and generate compressed hydrogen, a hydrogen cooler configured to cool the compressed hydrogen and provide a first portion of hydrogen, and a liquid hydrogen vaporizer configured to vaporize liquid hydrogen from the liquid hydrogen storage tank and provide a second portion of hydrogen, wherein at least one of the first portion of hydrogen or the second portion of hydrogen is supplied to a fuel cell system based on an amount of the BOG and an amount of hydrogen required by the fuel cell system.

### CROSS-REFERENCE TO RELATED APPLICATION

This application claims the benefit of priority to Korean Patent Application No. 10-2024-0137125, filed in the Korean Intellectual Property Office on Oct. 8, 2024, the entire contents of which are incorporated herein by reference.

### TECHNICAL FIELD

The present disclosure relates to a fuel cell, and more particularly, to a technology for controlling fuel supply for a fuel cell system.

### BACKGROUND

The matters described in this Background section are only for enhancement of understanding of the background of the disclosure, and should not be taken as acknowledgment that they correspond to prior art already known to those skilled in the art.

Carbon neutrality is a hot topic around the world. Major economies are seeking ways for expanding electricity production using renewable energy instead of fossil energy.

A green energy system is a system that uses, as electrical and hydrogen energy, energy obtained through the renewable energy such as wind power, hydro power, tidal power, and solar power.

Among them, green hydrogen is estimated as ultimate eco-friendly energy because the green hydrogen does emit no greenhouse gas from a production stage, and hydrogen, which is emerging as alternative energy at the global level, is roughly classified into gray hydrogen, blue hydrogen, and green hydrogen depending on a production method.

Research on electric vehicles equipped with eco-friendly hydrogen fuel cells is being actively conducted.

Hydrogen fuel-based electric vehicles may provide a fast charging time and a long driving distance with a single hydrogen charge due to high energy density thereof as compared to general electric vehicles based on high voltage batteries. However, a storage capacity of a hydrogen tank used in a hydrogen fuel-based electric vehicle may be limited due to excess gas (e.g., a boil-off gas) increasing pressure inside the hydrogen tank.

### SUMMARY

The present disclosure has been made to solve the above-mentioned problems.

According to the present disclosure, an apparatus may comprise, a hydrogen compressor configured to compress a boil-off gas (BOG) from a liquid hydrogen storage tank and generate compressed hydrogen, a hydrogen cooler configured to cool the compressed hydrogen and provide a first portion of hydrogen, and a liquid hydrogen vaporizer configured to vaporize liquid hydrogen from the liquid hydrogen storage tank and provide a second portion of hydrogen, wherein at least one of the first portion of hydrogen or the second portion of hydrogen is supplied to a fuel cell system based on an amount of the BOG and an amount of hydrogen required by the fuel cell system.

The apparatus, wherein the first portion of hydrogen is supplied to the fuel cell system based on a determination that the amount of the BOG is greater than the amount of hydrogen required by the fuel cell system.

The apparatus, wherein the first portion of hydrogen and the second portion of hydrogen are supplied to the fuel cell system based on a determination that the amount of the BOG is smaller than the amount of hydrogen required by the fuel cell system.

The apparatus, may further comprise, a liquid hydrogen pump provided inside or outside the liquid hydrogen storage tank and configured to provide the liquid hydrogen to the liquid hydrogen vaporizer, wherein the liquid hydrogen pump is driven based on a determination that the amount of the BOG is smaller than the amount of hydrogen required by the fuel cell system.

The apparatus, wherein the hydrogen compressor is configured to perform compression control or flow rate control, and wherein the compression control is performed based on a determination that the amount of the BOG is greater than the amount of hydrogen required by the fuel cell system, and wherein the flow rate control is performed based on a determination that the amount of the BOG is smaller than the amount of the hydrogen required by the fuel cell system.

The apparatus, may further comprise, a tank pressure regulator configured to reduce a pressure of the liquid hydrogen storage tank by discharging at least a portion of the BOG to an outside based on a determination that the amount of the BOG is greater than a predetermined reference value.

The apparatus, may further comprise, flow rate controller circuitry configured to control flow rates of hydrogen and air supplied to the fuel cell system based on the amount of hydrogen required by the fuel cell system.

The apparatus, wherein the flow rate control circuitry comprise, a hydrogen flow rate controller circuit configured to control the flow rate of the hydrogen supplied to the fuel cell system by adjusting a first valve based on a set point (SP)and a first processing variable, wherein the SP is determined based on the amount of hydrogen required by the fuel cell system, and wherein the first processing variable is acquired from a first flow rate measurement circuit configured to measure the flow rate of the hydrogen supplied to the apparatus, and an air flow rate controller circuit configured to control the flow rate of the air supplied to the fuel cell system by adjusting a second valve based on the SP, the first processing variable, and a second processing variable, wherein the second processing variable is acquired from a second flow rate measurement circuit configured to measure the flow rate of the air supplied to the fuel cell system.

The apparatus, wherein the air flow rate controller circuit is configured to, select a larger value of the SP and the first processing variable, and adjust the second valve based on the selected larger value and the second processing variable.

The apparatus, wherein the hydrogen compressor may comprise a plurality of compressors having a same type or different types of compressors arranged in parallel or series.

According to the present disclosure, a method performed by an apparatus may comprise, compressing, by a hydrogen compressor, a boil-off gas (BOG) from a liquid hydrogen storage tank of the apparatus and generating compressed hydrogen, cooling, by a hydrogen cooler of the apparatus, the compressed hydrogen and generating a first portion of hydrogen, and vaporizing, by a liquid hydrogen vaporizer of the apparatus, liquid hydrogen from the liquid hydrogen storage tank and generating a second portion of hydrogen, wherein at least one of the first portion of hydrogen or the second portion of hydrogen is supplied to a fuel cell system based on an amount of the BOG and an amount of hydrogen required by the fuel cell system.

The method, may further comprise, supplying the first portion of hydrogen to the fuel cell system based on a determination that the amount of the BOG is greater than the amount of hydrogen required by the fuel cell system.

The method, may further comprise, supplying the first portion of hydrogen and the second portion of hydrogen to the fuel cell system based on a determination that the amount of the BOG is smaller than the amount of hydrogen required by the fuel cell system.

The method, may further comprise, driving a liquid hydrogen pump based on a determination that the amount of the BOG is smaller than the amount of hydrogen required by the fuel cell system, wherein the liquid hydrogen from the liquid hydrogen storage tank is provided to the liquid hydrogen vaporizer by the driving the liquid hydrogen pump.

The method, wherein the compressing the BOG may comprise, performing a compression control based on a determination that the amount of the BOG is greater than the amount of hydrogen required by the fuel cell system, and performing a flow rate control based on a determination that the amount of the BOG is smaller than the amount of hydrogen required by the fuel cell system.

The method, may further comprise, reducing, by a tank pressure regulator of the apparatus, a pressure of the liquid hydrogen storage tank by discharging at least a portion of the BOG to an outside based on a determination that the amount of the BOG is greater than a predetermined reference value.

The method, may further comprise, controlling, by flow rate controller circuitry of the apparatus, flow rates of hydrogen and air supplied to the fuel cell system based on the amount of hydrogen required by the fuel cell system.

The method, wherein the controlling the flow rates of hydrogen and air may comprise, controlling, by a hydrogen flow rate controller circuit of the flow rate controller circuitry, the flow rate of the hydrogen supplied to the fuel cell system by adjusting a first valve based on a set point (SP) and a first processing variable, wherein the SP is determined based on the amount of hydrogen required by the fuel cell system, and wherein the first processing variable is acquired from a first flow rate measurement circuit configured to measure the flow rate of the hydrogen supplied to the apparatus, and controlling, by an air flow rate controller circuit of the flow rate controller circuitry, the flow rate of the air supplied to the fuel cell system by adjusting a second valve based on the SP, the first processing variable, and a second processing variable, wherein the second processing variable is acquired from a second flow rate measurement circuit configured to measure the flow rate of the air supplied to the fuel cell system.

The method, may further comprise, selecting, by the air flow rate controller circuit, a larger value of the SP and the first processing variable, and adjusting the second valve based on the selected larger value and the second processing variable.

According to the present disclosure, an apparatus may comprise, a processor, and a memory storing at least one instruction that, when executed by the processor communicating with the memory, is configured to cause the apparatus to, compress, using a compressor, a boil-off gas (BOG) from a liquid hydrogen storage tank and generate compressed hydrogen, cool, using a cooler, the compressed hydrogen and provide a first portion of hydrogen, vaporize, using a vaporizer, liquid hydrogen from the liquid hydrogen storage tank and provide a second portion of hydrogen, and control, based on an amount of the BOG and an amount of hydrogen required by a fuel cell system, output of at least one of the first portion of hydrogen or the second portion of hydrogen.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a structure of a fuel supply system for a fuel cell according to the related art;

FIG. 2 shows an example for describing an electricity generation principle of a fuel cell system according to the present disclosure;

FIG. 3 shows an example for describing a fuel cell fuel supply system according to an example of the present disclosure;

FIG. 4 shows an example for describing a process control loop according to the example of the present disclosure;

FIG. 5 shows an example for describing a detailed structure of the fuel cell fuel supply system according to the example of the present disclosure;

FIG. 6 shows an example for describing a control operation of a fuel supply system in a first mode according to the example of the present disclosure;

FIG. 7 shows an example for describing a control operation of the fuel supply system in a second mode according to the example of the present disclosure;

FIG. 8 shows an example for describing a control operation of the fuel supply system for controlling a fuel flow rate according to the example of the present disclosure;

FIG. 9 shows an example for describing a method of controlling a tank pressure in the fuel supply system for a fuel cell according to the example of the present disclosure;

FIG. 10 shows an example of a structure of a fuel supply controller for the fuel cell system according to the example of the present disclosure;

FIG. 11 shows an example of an operation of the fuel supply controller according to the example of the present disclosure;

FIG. 12 shows an example of an operation of a fuel supply controller according to another example of the present disclosure; and

FIG. 13 shows an example of a computing device according to the example of the present disclosure.

### DETAILED DESCRIPTION

Hereinafter, some examples of the present disclosure will be described in detail with reference to the exemplary drawings. In adding reference numerals to components of each drawing, it should be noted that identical or equivalent components are designated by an identical numeral even when they are displayed on other drawings. Further, in describing the example of the present disclosure, a detailed description of the related known configuration or function will be omitted when it is determined that it interferes with the understanding of the example of the present disclosure.

In describing the components of the example according to the present disclosure, terms such as first, second, A, B, (a), (b), and the like may be used. These terms are merely intended to distinguish one component from other components, and the terms do not limit the nature, order, or sequence of the components. Unless otherwise defined, all terms including technical and scientific terms used herein include the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

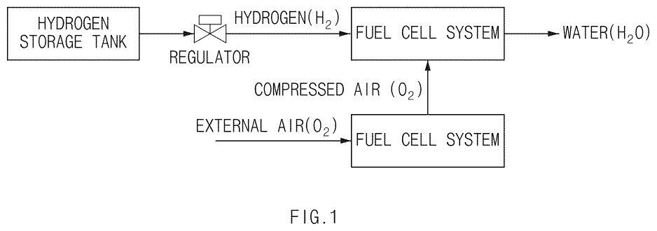

As illustrated in FIG. 1, a fuel cell fuel supply system is configured to supply hydrogen stored in a high-pressure hydrogen storage tank to a fuel cell system by adjusting the hydrogen to a certain pressure through a regulator valve and to supply compressed external air to the fuel cell system through an air compressor.

However, a container pressure of a liquid hydrogen storage tank provided in a hydrogen fuel cell electric vehicle may increase due to a boil-off gas (BOG) when an internal/external temperature difference occurs. In particular, since hydrogen, which is a fuel, is stored in a storage tank in the form of a high-pressure gas, a storage capacity of a hydrogen tank decreases when the amount of the BOG increases. The fuel cell system(s) described herein may be used for various facilities, devices, hydrogen generators, vehicles (e.g., fuel cell vehicles), etc.

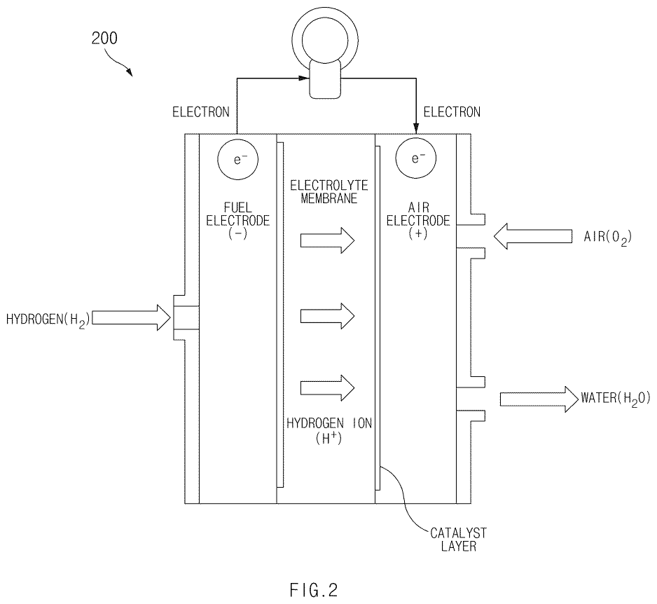

Hereinafter, examples of the present disclosure will be described in detail with reference to FIGS. 2 to 13.

FIG. 2 shows an example for describing an electricity generation principle of a fuel cell system according to the present disclosure.

Referring to FIG. 2, a fuel cell system 200 may roughly include a fuel electrode as a negative electrode, an air electrode as a positive electrode, and an electrolyte membrane disposed between the fuel electrode and the air electrode (e.g., a proton exchange membrane or a solid oxide electrolyte, etc.).

Catalyst layers are formed to allow a chemical reaction to occur in the fuel cell stack and may be included on both a front side and a rear side of the electrolyte membrane. For example, the catalyst layer may be formed using carbon powder coated with a platinum-based catalyst, but this is merely an example, and other catalyst materials (palladium, ruthenium, or iridium-based catalysts, etc.) may be used depending on a design of those skilled in the art.

When hydrogen (H₂) gas is injected through a hydrogen inlet formed on one side of the fuel electrode, the hydrogen reacts with the catalyst and is decomposed into hydrogen ions (H⁺) and electrons (e⁻). For example, the hydrogen inlet may include a diffuser or a flow-field plate to ensure even hydrogen distribution across the electrode.

The hydrogen ions pass through the electrolyte membrane and move to the air electrode, and the electrons generated from the fuel electrode pass through an external circuit and generate a current. In this case, a motor of an electric vehicle may be driven using the generated current. Additionally, auxiliary systems such as power electronics or DC-DC converters may regulate the output for improved efficiency. A current generated in the fuel cell stack may be used to charge a battery (e.g., lithium-ion, solid-state, or nickel-metal hydride battery, etc.) provided in the electric vehicle.

When oxygen (O₂) is injected through an air inlet formed on one side of the air electrode, the hydrogen ions react with the electrons and oxygen to generate water, and the generated water is discharged (e.g., either in liquid or vapor form, depending on temperature and humidity conditions) to the outside through a water outlet formed on the other side of the air electrode.

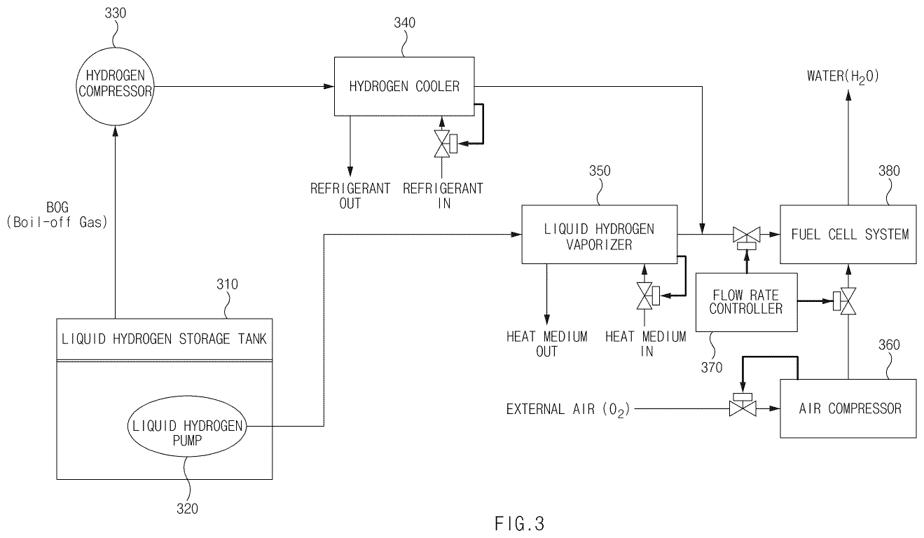

FIG. 3 shows an example for describing a fuel cell fuel supply system according to an example of the present disclosure.

Hereinafter, for convenience of description, a fuel supply system for the fuel cell system will be simply referred to as a fuel supply system.

Referring to FIG. 3, a fuel supply system 300 may include a liquid hydrogen storage tank 310, a liquid hydrogen pump 320, a hydrogen compressor 330, a hydrogen cooler 340, a liquid hydrogen vaporizer 350, an air compressor 360, a flow rate controller 370, and a fuel cell system 380. Additional components, such as pressure sensors, temperature regulators, or safety valves, etc., may also be included to optimize performance and ensure safety.

In the present example, a path through which hydrogen stored in the liquid hydrogen storage tank 310 is supplied to the fuel cell system 380 may include a first path and a second path. Each path may operate independently or simultaneously depending on the fuel demand and system conditions.

The first path is a path through which a boil-off gas (BOG) of the liquid hydrogen storage tank 310 is compressed by the hydrogen compressor 330, cooled using the hydrogen cooler 340, and then supplied to the fuel cell system 380. The second path is a path through which liquid hydrogen stored in the liquid hydrogen storage tank 310 is suctioned and discharged through the liquid hydrogen pump 320, transferred to the liquid hydrogen vaporizer 350, and converted into gaseous hydrogen before being supplied to the fuel cell system 380. This dual-path approach may enable efficient fuel utilization by adapting to varying hydrogen demands and minimizing fuel loss.

The fuel supply system 300 according to the example may measure the amount of the BOG in the liquid hydrogen storage tank 310 and adaptively select at least one of the first path or the second path according to the measured amount of the BOG to supply the hydrogen to the fuel cell system 380.

The hydrogen compressor 330 may be implemented as a single compressor, but this is merely an example. Alternatively, the hydrogen compressor may be implemented with a plurality of compressors arranged in parallel or series to compress the BOG.

For example, the hydrogen compressor may include a diaphragm type compressor, a hydraulic (piston) type compressor, an ionic type compressor, or a screw-type compressor, etc. The diaphragm type is a type that compresses a hydrogen gas by operating a diaphragm using a hydraulic force. The hydraulic type and the ionic type are types that compress the hydrogen gas by driving a piston in a cylinder using a hydraulic pressure. A screw-type compressor is a type that uses two interlocking helical rotors (screws) to compress gas and may be used for relatively high-flow applications.

In the example, the liquid hydrogen pump 320 may be implemented as a single pump according to a type of applied pump, but this is merely an example. Alternatively or additionally, the liquid hydrogen pump 320 according to another example may be implemented in a structure in which the same or different types of pumps (e.g., cryogenic pumps, centrifugal pumps, or positive displacement pumps, etc.) are arranged in parallel or in series to increase flow capacity and/or redundancy.

FIG. 3 shows that the liquid hydrogen pump 320 is disposed on one inner side of the liquid hydrogen storage tank 310, but this is merely an example Alternatively or additionally, the liquid hydrogen pump 320 according to another example may be implemented to be disposed in an inner portion of the liquid hydrogen storage tank 310.

For example, the liquid hydrogen pump 320 may include a turbo-type centrifugal pump, a reciprocating pump, rotating volume pump, a gear pump, and the like. Each pump type offers distinct advantages in terms of flow rate, pressure output, and efficiency, making selection dependent on system design parameters.

Various materials may be used as a refrigerant for the hydrogen cooler 340 and as a heat medium for the liquid hydrogen vaporizer 350. For example, the refrigerant may be liquid nitrogen, helium, or hydrofluorocarbon-based coolants, etc. For example, the common heat media may be water, ethylene glycol mixtures, or phase-change materials, etc.

The fuel supply system 300 according to the example may control at least one of the amount of a refrigerant used and a type of refrigerant input to the hydrogen cooler 340, for example, to regulate temperature and enhance cooling performance.

Further, the fuel supply system 300 according to the example may control at least one of the amount of a heat medium or the type of heat medium input to the liquid hydrogen vaporizer 350, for example, to ensure efficient phase transition from liquid to gaseous hydrogen.

Further, the fuel supply system 300 according to the example may control the amount of external air entering the air compressor 360, for example, to maintain a desirable air-to-fuel ratio in the fuel cell system.

The flow rate controller 370 may adjust the amount of fuel actually delivered to the fuel cell system 380. Here, the fuel includes hydrogen and air (oxygen). Alternatively or additionally, the flow rate controller 370 may use real-time feedback from sensors to dynamically adjust flow rates based on fuel cell load requirements.

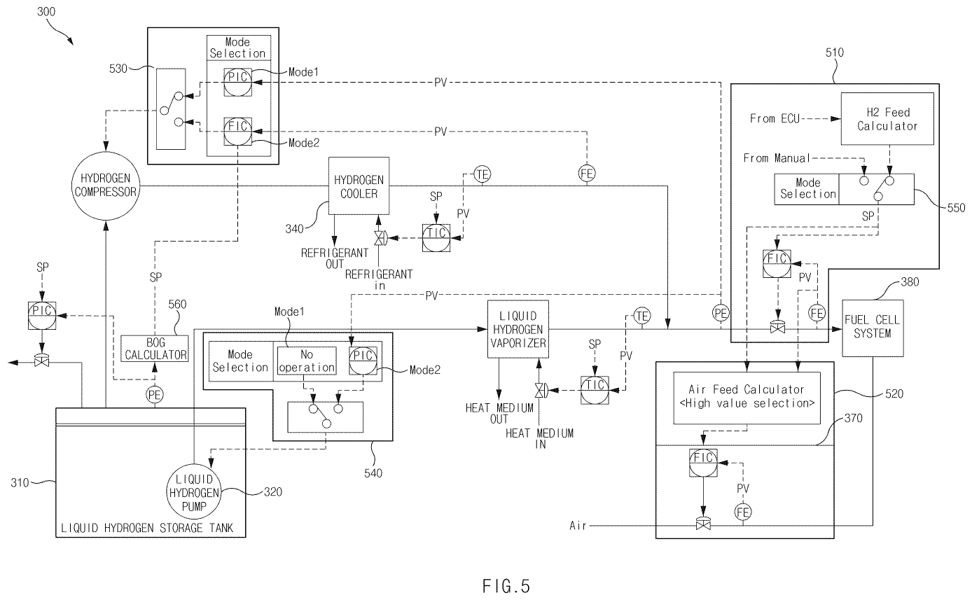

As illustrated in FIGS. 5 to 9, which will be described below, the flow rate controller 370 according to the example may include a hydrogen flow rate controller 510 and an air flow rate controller 520.

The air flow rate controller 520 may calculate an air flow rate to be supplied to the fuel cell system 380 based on a set point (SP) and a process variable (PV) determined and measured by the hydrogen flow rate controller 510. For example, the air flow rate may be dynamically adjusted based on external conditions such as ambient temperature, humidity, or altitude, etc., to enhance fuel cell efficiency.

In the example, the flow rate controller 370 may be driven according to a control signal received from a vehicle ECU or a user manual. As an example, the vehicle ECU may transmit information on a required output to the flow rate controller 370, and the flow rate controller 370 may calculate a hydrogen flow rate corresponding to the required output and automatically calculate an air flow rate required for a chemical reaction based on the calculated hydrogen flow rate. The flow rate controller 370 may control each regulator according to the calculated hydrogen flow rate and the calculated air flow rate to adjust a fuel flow rate delivered into the fuel cell system 380. For example, the flow rate controller 370 may predict optimal flow rates based on historical driving patterns or external environmental factors. For example, a high value selection algorithm that calculates the required air flow rate based on whichever is higher between the SP value and the PV value from the hydrogen flow rate controller 510 may be applied to the flow rate controller 370. Additionally, the air flow rate controller 520 may incorporate fail-safe mechanisms to prevent excessive air intake, ensuring stable fuel cell operation.

In general, there are three variables in the control system. Here, the three variables include the SP that is a set point, the PV that is a process variable, and an OP that is an output. The PV is a parameter (e.g., a temperature, a flow rate, a density, a pressure, or a concentration, etc.) to be controlled and is a value transmitted to a controller by a measurement element. The SP is a desired value for the PV, and the OP is a value sent from the flow rate controller 370 to an actuator and has a range defined as 0% to 100%. The fuel supply system 300 according to the example of the present disclosure may include a controller including a pressure indicator and controller (PIC) for indicating and controlling an output pressure, a temperature indicator and controller (TIC) for indicating and controlling an output temperature, and a flow rate indicator and controller (FIC) for indicating and controlling an output flow rate. Each of these controllers may work in coordination with other vehicle subsystems to maintain stability and prevent overloading. The fuel supply system 300 according to the example of the present disclosure may include a measurement element including a pressure element (PE) for measuring a pressure of a fluid, a temperature element (TE) for measuring a temperature of the fluid, and a flow rate element (FE) for measuring a flow rate. These measurement elements may incorporate real-time data analytics to detect anomalies, enabling predictive maintenance or system diagnostics, etc.

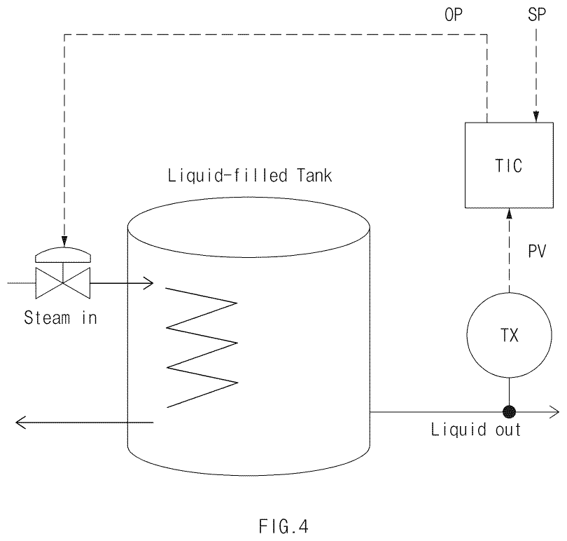

FIG. 4 shows an example for describing a process control loop according to the example of the present disclosure.

A hardware and/or software component for forming a process control loop may roughly include a controller (C), a control element (CE), and a measurement element (ME). For example, the controller may be a programmable logic controller (PLC), a microcontroller, or an embedded system. The control element may be a valve, a pump, or a compressor, etc. The measurement element may be a pressure sensor, a flow meter, or a temperature sensor, etc.

A control variable for the process control loop may roughly include the SE, the PV or the MV, and the output OP. Here, the SP is a value set by the controller, the PV or the MV is a value transmitted by the measurement element to the controller, and the OP is a value transmitted by the controller to the control element. For example, in a hydrogen fuel supply system, the SP may represent the desired hydrogen flow rate, the PV may be the actual flow rate measured by a sensor, and the OP may be the signal sent to adjust a hydrogen pump or a compressor.

The SP, which is a desired value for a process output, may be preset by an operator of a corresponding system, calculated during system operation, or set based on a signal received from an external source. For example, in an automotive fuel cell system, the SP may be dynamically adjusted based on driving conditions, battery charge levels, or power demands from auxiliary systems, etc.

The PV or the MV is a measurement value for the process output. For example, in a liquid hydrogen storage system, the PV may correspond to the measured tank pressure, while the MV may represent the computed mass flow rate of hydrogen vaporized for fuel cell use.

The OP is a variable for controlling an actuator that is a control element or another controller and is output of the controller. For example, in a hydrogen supply system, the OP may control the speed of a liquid hydrogen pump, open or close a solenoid valve, or adjust the compression rate of a hydrogen compressor.

Hereinafter, a simple single input-single output (SISO) feedback control loop for controlling the temperature of the fluid will be described with reference to FIG. 4.

A TX, which is a temperature measuring sensor, may measure the temperature of the fluid discharged from a liquid-filled tank and transmit the PV, which is a measurement temperature value to the TIC. The TIC may determine the OP based on the set SP value and the set PV value and may adjust a steam flow control valve using the determined OP. For example, the TIC may control the temperature of the fluid discharged from a tank by adjusting the amount of steam flowing into the tank. For example, in the fuel supply system of the present disclosure, steam or a controlled heat source may be used in the liquid hydrogen vaporizer to facilitate the phase transition of liquid hydrogen (L-H₂) into gaseous hydrogen (H₂) before supplying it to the fuel cell system. By precisely controlling the heat input, the system may control hydrogen vaporization while preventing excessive boil-off gas (BOG) formation, ensuring stable and efficient fuel delivery.

Although the process control loop for controlling the temperature of the fluid has been described in the example of FIG. 4, the process control loop according to the example of the present disclosure may be used to control not only the temperature of the fluid, but also the density (e.g., gas pressure in a hydrogen storage tank, liquid density in a cryogenic vessel, or plasma density in an electrolysis reactor, etc.) and the flow (e.g., volumetric flow rate of hydrogen gas, mass flow rate of liquid hydrogen, or air intake flow rate in a fuel cell, etc.) of the fluid.

FIG. 5 shows an example for describing a detailed structure of the fuel cell fuel supply system according to the example of the present disclosure.

Referring to FIGS. 3 and 5, the fuel supply system 300 may include a first selection controller 530 for controlling an operation mode of the hydrogen compressor 330, a second selection controller 540 for controlling the driving of the liquid hydrogen pump 320, and a third selection controller 550 for selectively receiving information on the amount of the required hydrogen. Additionally, for example, the fuel supply system 300 may include auxiliary controllers (e.g., a safety controller for emergency shutdown, a temperature controller for cryogenic stability, or a fault detection controller for real-time diagnostics, etc.) to enhance reliability and operational efficiency.

The first selection controller 530 may control the hydrogen compressor 330 to perform pressure control using the PIC in a first mode (e.g., when the available boil-off gas (BOG) exceeds the required hydrogen demand), and may control the hydrogen compressor 330 to perform flow rate control using the FIC in a second mode (e.g., when the required hydrogen exceeds the available BOG, necessitating additional liquid hydrogen vaporization).

The second selection controller 540 may control the liquid hydrogen pump 320 to remain inactive in the first mode (e.g., to prioritize BOG utilization). The second selection controller 540 may activate the liquid hydrogen pump 320 to perform pressure control using the PIC in the second mode (e.g., to deliver liquid hydrogen to the vaporizer for additional hydrogen gas supply). The second selection controller 540 may further implement variable-speed control for the liquid hydrogen pump 320 (e.g., adjusting RPM based on real-time hydrogen demand) to improve energy efficiency.

The third selection controller 550 may selectively control whether to receive information on the amount of the required hydrogen from an ECU or from a user manual and may provide the SP corresponding to the amount of the required hydrogen to the flow rate controller 370. For example, the ECU may dynamically adjust hydrogen demand based on real-time fuel cell power output, while a manual setting may be used for system calibration or testing purposes.

The fuel supply system 300 according to the example may include a BOG calculator 560 that calculates the amount of available BOG, i.e., a hydrogen amount, based on a pressure of the liquid hydrogen storage tank 310. The BOG calculator 560 may provide the SP corresponding to the amount of the available BOG to the first selection controller 530. For example, the BOG calculator 560 may also account for external factors (e.g., ambient temperature fluctuations, vehicle idle time, or rapid acceleration events, etc.) that influence BOG generation, ensuring adaptive fuel management.

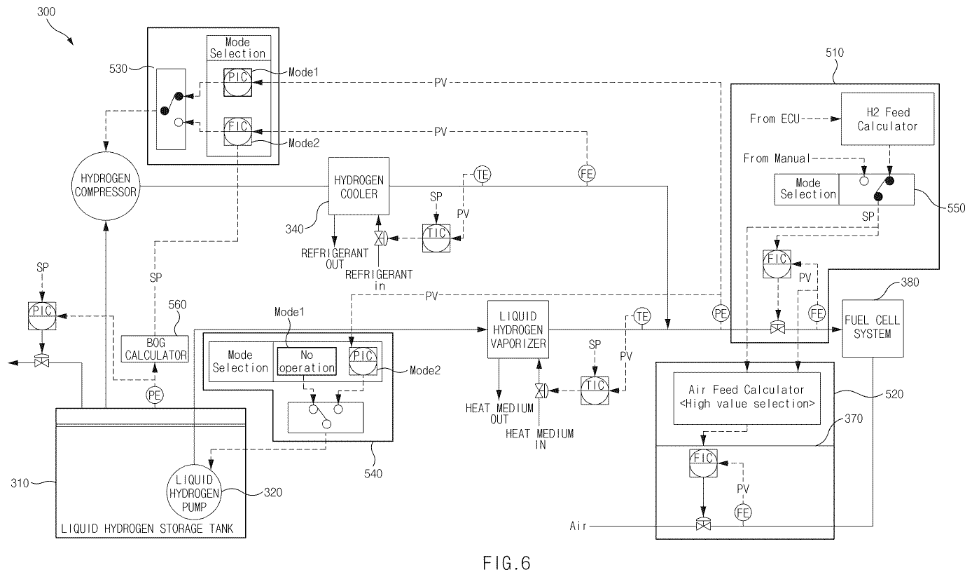

FIG. 6 shows an example for describing a control operation of a fuel supply system in a first mode according to the example of the present disclosure.

Referring to FIG. 6, in the first mode (or Mode 1), the hydrogen compressor 330 may be controlled to perform pressure control, and the liquid hydrogen pump 320 may be controlled to remain inactive (e.g., not driven). Here, one or more of revolution per minute (RPM) control, guide vane control, and bypass control (e.g., variable inlet guide vanes, adjustable diffuser settings, or automatic bypass valve modulation, etc.) may be used for pressure control. This may ensure that the fuel supply system efficiently regulates hydrogen supply while reducing or minimizing energy consumption and excess heat generation.

In the first mode, the amount of essential hydrogen may be input from the ECU or the user manual. For example, the ECU may dynamically adjust the hydrogen demand based on vehicle acceleration, fuel cell load, or battery charge state, while a user manual input may be used during system calibration, diagnostic testing, or emergency override conditions.

In the first mode, the hydrogen cooler 340 may control an input flow rate of the refrigerant according to the SP. Here, the SP may be variable, and the input flow rate of the refrigerant may be adjusted by the TIC based on the PV from the TE and the set SP. For example, various refrigerants may be used (e.g., liquid nitrogen, helium, or hydrofluorocarbons, etc.) depending on the cooling efficiency requirements and ambient operating conditions.

In the first mode, the hydrogen flow rate supplied to the fuel cell system 380 may be determined based on the amount of the required hydrogen received from the ECU or the user manual, and an oxygen flow rate may be determined based on the determined hydrogen flow rate. To this end, the SP and the PV in the hydrogen flow rate controller 510 may be provided to the air flow rate controller 520. For example, the air flow rate controller 520 may incorporate compensation factors (e.g., altitude adjustments, temperature fluctuations, or humidity levels, etc.) to enhance or optimize the oxygen-to-hydrogen ratio for stable fuel cell operation.

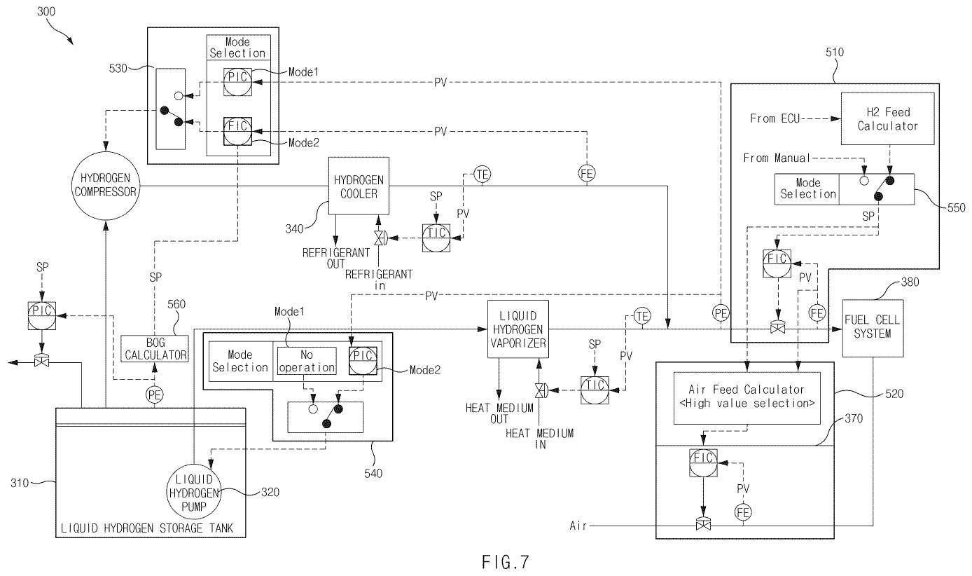

FIG. 7 shows an example for describing a control operation of the fuel supply system in a second mode according to the example of the present disclosure.

Referring to FIG. 7, in the second mode (or Mode 2), the hydrogen compressor 330 may be controlled to perform flow rate control, and the liquid hydrogen pump 320 may be controlled to be driven through pressure control. For example, in this mode, the fuel supply system may prioritize maintaining a stable hydrogen supply by dynamically adjusting pump operation, ensuring that sufficient hydrogen gas is available to meet fuel cell demand even when boil-off gas (BOG) is insufficient.

In the second mode, the amount of the essential hydrogen may be input from the ECU or the user manual. For example, the ECU may determine the hydrogen requirement based on real-time vehicle speed, power demand, or environmental factors (e.g., altitude or temperature, etc.), while a user manual input may be used for maintenance operations, performance testing, or system overrides, etc.

In the second mode, the hydrogen cooler 340 may control the input flow rate of the refrigerant according to the SP. Here, the SP may be variable, and the input flow rate of the refrigerant (e.g., nitrogen, helium, or hydrofluorocarbons, etc.) may be determined by the TIC based on the PV from the TE and the set SP. For example, different refrigerant may be used depending on cooling efficiency requirements, ambient conditions, and system constraints.

In the second mode, the liquid hydrogen vaporizer 350 may control an input flow rate of the heat medium (e.g., water-glycol mixtures, thermal oils, or phase-change materials, etc.) according to the SP. Here, the SP may be variable, and the input flow rate of the heat medium may be adjusted by the TIC based on the PV from the TE and the set SP. Various heat transfer fluids (e.g., water-glycol mixtures, thermal oils, or phase-change materials, etc.) may be used to improve vaporization efficiency and ensure stable hydrogen gas output.

In the second mode, the hydrogen compressor 330 may supply only the available amount, and one or more of the RPM control, variable guide vane control, and automated bypass control (e.g., modulating compressor load based on real-time hydrogen consumption) may be used for flow rate control. This adaptive control may help prevent excessive power consumption while ensuring continuous hydrogen delivery to the fuel cell system.

In the second mode, the hydrogen flow rate supplied to the fuel cell system 380 may be determined based on the amount of the required hydrogen received from the ECU or the user manual, and the oxygen flow rate may be determined based on the determined hydrogen flow rate. To this end, the SP and the PV in the hydrogen flow rate controller 510 may be provided to the air flow rate controller 520. For example, the air flow rate controller 520 may also consider environmental compensation factors (e.g., humidity levels, atmospheric pressure, or intake air temperature, etc.) to maintain a desirable or optimal oxygen-to-hydrogen ratio for efficient fuel cell operation.

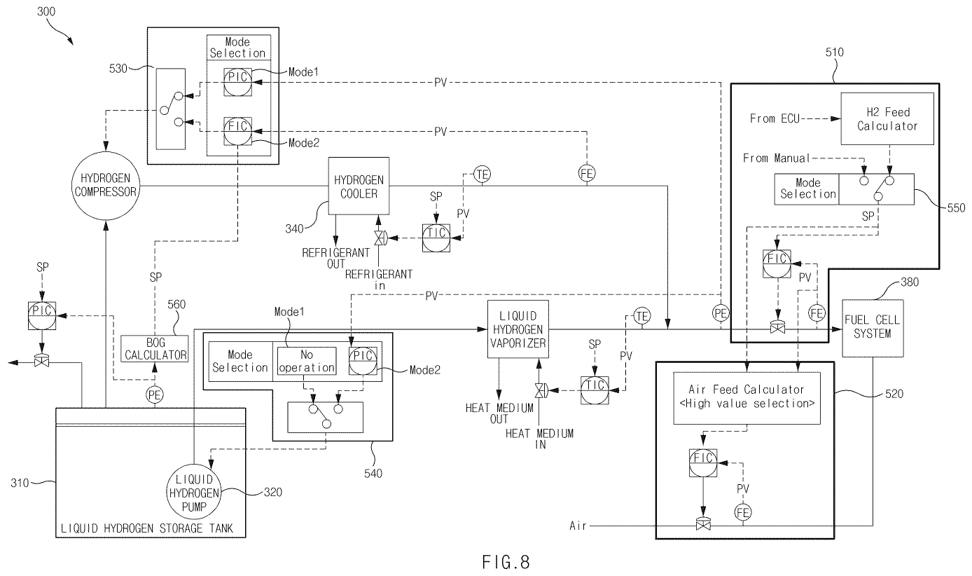

FIG. 8 shows an example for describing a control operation of the fuel supply system for controlling a fuel flow rate according to the example of the present disclosure.

Referring to FIG. 8, the hydrogen flow rate controller 510 may calculate the amount of the required hydrogen based on the information received from the ECU (e.g., hydrogen demand based on vehicle acceleration, regenerative braking status, or battery state-of-charge (SOC), etc.) or the user manual (e.g., a manual setting for system calibration, diagnostic testing, or emergency fuel adjustments, etc.).

The hydrogen flow rate controller 510 may set the SP corresponding to the calculated amount of the required hydrogen. The hydrogen flow rate controller 510 may include the FIC, and the FIC may control a hydrogen flow rate control valve based on the PV received from the FE thereof and the set SP. For example, the hydrogen flow rate controller 510 may incorporate predictive factors (e.g., based on demand forecasting, historical driving pattern analysis, or real-time load estimation, etc.) to improve flow rate accuracy and system efficiency.

The SP and the PV of the hydrogen flow rate controller 510 may be transmitted to the air flow rate controller 520. In this case, the FIC of the air flow rate controller 520 may control an air flow rate control valve based on the SP and the PV received from the hydrogen flow rate controller 510 and the PV received from the FE thereof. The air flow rate controller 520 according to the example may control the air flow rate control valve by calculating a required air flow rate based on whichever the higher value of the SP and the PV of the hydrogen flow rate controller 510. For example, environmental factors (e.g., altitude, humidity, ambient air temperature, or atmospheric pressure, etc.) may be considered to control air intake, ensuring a desirable or ideal oxygen-to-hydrogen ratio for stable fuel cell operation.

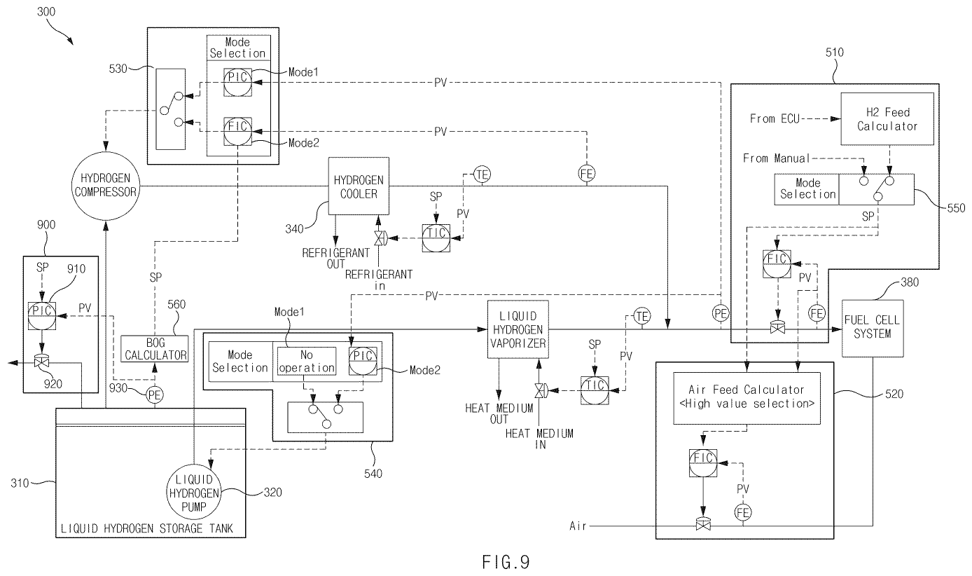

FIG. 9 shows an example for describing a method of controlling a tank pressure in the fuel supply system for a fuel cell according to the example of the present disclosure.

Referring to FIG. 9, the fuel supply system 300 according to the example of the present disclosure may further include a tank pressure regulator 900. The tank pressure regulator 900 is configured to maintain a desirable or ideal pressure within the liquid hydrogen storage tank 310, preventing excessive pressure buildup that could lead to safety hazards or hydrogen loss.

The tank pressure regulator 900 may include a PIC 910 and a tank pressure discharge valve 920. For example, the fuel supply system 300 may also integrate auxiliary components (e.g., a pressure relief valve, a vacuum-insulated vent system, or a redundant backup regulator, etc.) to enhance the reliability and safety of the fuel supply system 300.

The PIC 910 may open the tank pressure discharge valve 920 based on a preset SP and the PV obtained from a PE 930 that measures the pressure of the liquid hydrogen storage tank 310. For example, the PE 930 may continuously monitor real-time tank pressure variations caused by environmental factors (e.g., ambient temperature fluctuations, rapid acceleration, or extended vehicle idle periods, etc.), ensuring that adjustments or corrective actions are taken.

As an example, the PIC 910 may open the tank pressure discharge valve 920 when the tank pressure exceeds a predetermined reference value. This process may help prevent excessive boil-off gas (BOG) accumulation and ensure the stable operation of the hydrogen supply system. When there is no hydrogen in the liquid hydrogen storage tank 310, the tank pressure regulator 900 may stop controlling the tank pressure. For example, in such a scenario, the fuel supply system 300 may trigger an alert (e.g., a low-pressure warning, a system shutdown protocol, or an automatic switchover to an alternative fuel source, etc.) to prevent fuel starvation and maintain vehicle performance.

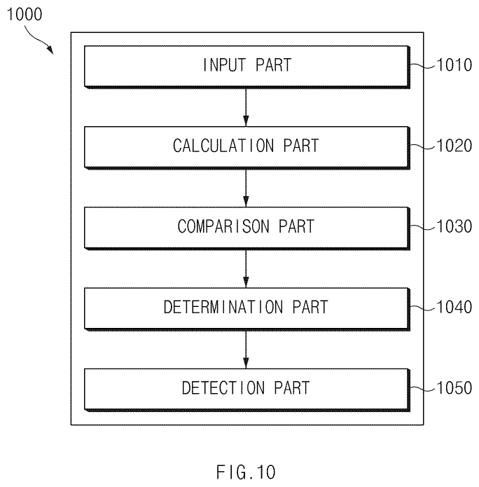

FIG. 10 shows an example of a structure of a fuel supply controller for the fuel cell system according to the example of the present disclosure. The fuel supply controller may regulate hydrogen supply, ensuring stable fuel delivery while improving efficiency based on real-time demand.

A fuel supply controller 1000 according to the present example may include hardware including at least one controller (e.g., a microcontroller unit (MCU), a programmable logic controller (PLC), or an embedded system, etc.) and an operator interface (e.g., a touchscreen panel, a diagnostic port, or a manual override switch, etc.) and software implemented to control the fuel cell system's operation.

Referring to FIG. 10, the fuel supply controller 1000 may include an input part 1010, a calculation part 1020, a comparison part 1030, a determination part 1040, and a detection part 1050. These components may work in coordination to regulate hydrogen flow and ensure system safety.

The input part 1010 may receive information on the amount of the required hydrogen according to the ECU or the user manual after a vehicle starts. For example, the ECU may dynamically adjust hydrogen demand based on powertrain load, ambient conditions (e.g., altitude or temperature, etc.), or energy recovery scenarios such as regenerative braking, etc.

The calculation part 1020 may calculate the amount of the BOG that may be transmitted from the liquid hydrogen storage tank 310 by measuring the pressure in the liquid hydrogen storage tank 310. This may ensure efficient utilization of available hydrogen while reducing or minimizing fuel loss due to excessive venting.

The comparison part 1030 may compare the amount of the required hydrogen received by the input part 1010 with the amount of the BOG calculated by the calculation part 1020. Based on this comparison, the fuel cell system may prioritize using BOG before engaging the liquid hydrogen pump, thereby improving fuel efficiency and reducing operational costs.

The determination part 1040 may determine a fuel supply mode based on the comparison result of the comparison part 1030. As an example, if the amount of the BOG is greater than the amount of the required hydrogen, the determination part 1040 may select the first mode in which hydrogen is supplied to the fuel cell only using the BOG. On the other hand, if the amount of the BOG is smaller than or equal to the amount of the required hydrogen, the determination part 1040 may select the second mode in which the hydrogen is supplied via a combination of pressure control of the transmittable BOG and the liquid hydrogen pump 320. This dual-mode approach may allow for adaptive fuel management, reducing unnecessary energy consumption by the pump when sufficient BOG is available.

The determination part 1040 according to the example may determine whether tank pressure regulation or discharge is required based on a comparison between the pressure of the liquid hydrogen storage tank 310 and a predetermined reference value. When the tank pressure discharge is required, the determination part 1040 may trigger opening of the tank pressure discharge valve 920 as shown in FIG. 9. This feature may help prevent over-pressurization, ensuring the fuel cell system remains within safe operational limits.

The detection part 1050 may detect whether the vehicle is turned off or remains inactive during fuel supply control, and when such inactivity (e.g., stop starting) is detected, the fuel supply control may be terminated. This may prevent unnecessary hydrogen circulation when the vehicle is not in use, improving overall energy efficiency.

Further, the detection part 1050 may detect no hydrogen remaining in the liquid hydrogen storage tank 310. For example, in response, the fuel cell system may trigger a low-fuel alert, engage a backup fuel source (if available), or initiate a shutdown protocol to prevent air ingress and potential fuel cell damage.

In the example, the hydrogen compressor 330 may control the density and pressure of supplied hydrogen by performing pressure control in the first mode (when relying on BOG alone) and may perform flow rate control with the amount of transmittable BOG to modulate the amount of hydrogen gas produced from liquid hydrogen in the second mode. This may allow for precise hydrogen delivery tailored to real-time fuel cell demand.

In the example, the fuel supply controller 1000 may control the liquid hydrogen pump 320 to remain in active (e.g., not to be driven) in the first mode but to activate only in the second mode through pressure control. For example, variable-speed control of the liquid hydrogen pump 320 may be also implemented to adjust the pump operation based on demand, reducing or minimizing power consumption while ensuring adequate hydrogen supply.

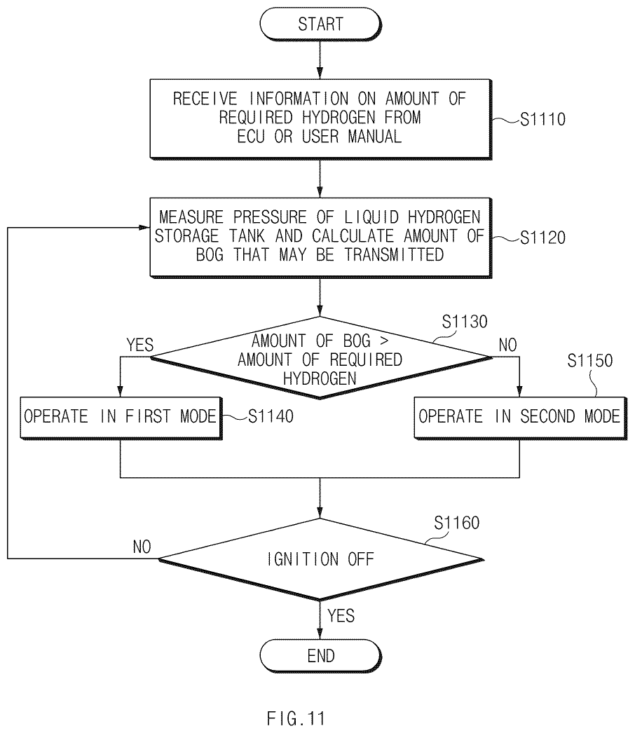

FIG. 11 shows an example of an operation of the fuel supply controller according to the example of the present disclosure.

Referring to FIG. 11, when the vehicle is turned on, the fuel supply controller 1000 may receive information on the amount of the required hydrogen from the ECU or the user manual (S1110). For example, the ECU may determine hydrogen demand based on factors such as vehicle acceleration, battery charge level, or power demand from auxiliary systems (e.g., climate control, infotainment, or regenerative braking, etc.), while a user manual input may be used for maintenance, diagnostics, or emergency override settings, etc.

The fuel supply controller 1000 may measure the pressure of the liquid hydrogen storage tank 310 and calculate the amount of the BOG that may be transmitted from the liquid hydrogen storage tank 310 based on the measured pressure (S1120). This process may ensure that available hydrogen is efficiently utilized before engaging the liquid hydrogen pump, reducing energy consumption and preventing unnecessary venting.

The fuel supply controller 1000 may compare the amount of the BOG with the amount of the required hydrogen (S1130). If the available BOG exceeds the required hydrogen, the fuel supply controller may prioritize its usage to reduce or minimize liquid hydrogen consumption and maintain cryogenic stability within the tank.

The fuel supply controller 1000 may control the fuel supply system 300 to operate in the first mode as illustrated in FIG. 6 when the amount of the BOG is sufficient to meet the required hydrogen demand (e.g., the amount of the BOG is greater than the amount of the required hydrogen) (S1140). The first mode improves efficiency by utilizing naturally evaporated hydrogen before activating energy-intensive components, such as the liquid hydrogen pump.

The fuel supply controller 1000 may control the fuel supply system 300 to operate in the second mode as illustrated in FIG. 7 when the amount of the BOG is insufficient to meet the required hydrogen demand (e.g., the amount of the BOG is smaller than or equal to the amount of the required hydrogen) (S1150). In this case, the fuel supply controller 1000 may activate the liquid hydrogen pump and vaporizer to convert liquid hydrogen into gas, ensuring an uninterrupted fuel supply to the fuel cell system.

When an ignition OFF is detected during the operation in the first mode or the second mode, the fuel supply controller 1000 may terminate the fuel supply process (S1160). For example, the fuel supply controller 1000 may also initiate safety protocols such as purging hydrogen lines, closing supply valves, or engaging venting mechanisms to prevent pressure buildup and ensure system stability.

The fuel supply controller 1000 may adaptively select and control the fuel supply mode by continuously (or periodically) performing operations 1120 and 1130 during the operation in the first mode or the second mode. This adaptive control may allow the fuel cell system to respond dynamically to real-time changes in hydrogen consumption, vehicle load, or environmental conditions (e.g., external temperature fluctuations, altitude changes, or prolonged idling, etc.), ensuring optimal fuel efficiency and reliability.

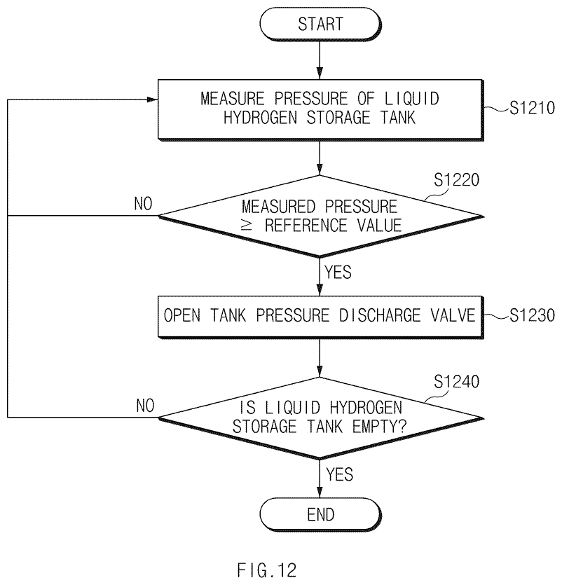

FIG. 12 shows an example of an operation of a fuel supply controller according to another example of the present disclosure.

Referring to FIGS. 10 and 12, the fuel supply controller 1000 may measure the pressure of the liquid hydrogen storage tank 310 (S1210). The pressure measurement is used for ensuring safe storage conditions and preventing excessive boil-off gas (BOG) buildup. The fuel cell system may use various types of pressure sensors (e.g., piezoelectric sensors, capacitive pressure transducers, or strain gauge sensors, etc.) to obtain accurate readings.

The fuel supply controller 1000 may compare the measured pressure with a predetermined reference value (S1220). For example, the predetermined reference value may be adjusted based on external factors such as ambient temperature, vehicle operating mode (e.g., idle, acceleration, or deceleration, etc.), or historical pressure trends to optimize system performance.

The fuel supply controller 1000 may control the tank pressure discharge valve 920 of FIG. 9 to be opened based on a measured pressure that is greater than or equal to a reference value (S1230). By doing so, the fuel supply controller 1000 may prevent over-pressurization that could lead to excessive BOG venting or compromised tank integrity. For example, vented hydrogen may be redirected to a secondary storage unit, a catalytic recombination system, or an energy recovery module to reduce or minimize waste.

When there is no hydrogen in the liquid hydrogen storage tank 310, the fuel supply controller 1000 may terminate tank pressure discharge control (S1240). For example, in such cases, the fuel supply controller 1000 may trigger a low-pressure warning, disable the hydrogen supply path to prevent air ingress, or activate a redundant fuel source (if available) to ensure continuous operation.

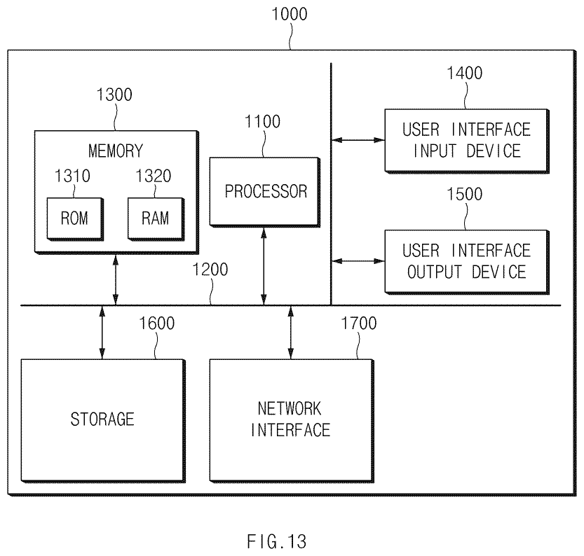

FIG. 13 shows an example of a computing device according to the example of the present disclosure.

Referring to FIG. 13, a computing device 1300 may include at least one of at least one processor 1320, a memory 1330, a user interface input device 1340, a user interface output device 1350, storage 1360, and a network interface 1370 that are connected through a bus 1310. The computing device 1300 may be used for various applications, such as real-time hydrogen fuel management, predictive maintenance, or autonomous control of fuel cell systems.

The processor 1320 may be a central processing unit (CPU) or a semiconductor device that processes commands stored in the memory 1330 and/or the storage 1360. Alternatively, the processor 1320 may include an advanced processing unit such as a graphics processing unit (GPU), a field-programmable gate array (FPGA), or a neural processing unit (NPU) to enhance computational efficiency for AI-based optimizations. The memory 1330 and the storage 1360 may include various types of volatile or nonvolatile storage media (e.g., dynamic random-access memory (DRAM) or static RAM (SRAM), while nonvolatile memory may include NAND flash storage, magneto resistive RAM (MRAM), or resistive RAM (ReRAM), etc.). For example, the memory 1330 may include a read only memory (ROM) 1331 and a random access memory (RAM) 1332.

Thus, the operations of the method (or procedure) or the algorithm described in connection with the examples disclosed herein may be directly implemented by hardware modules, software modules, or a combination of both the hardware modules and the software modules, which are executed by the processor 1320. The software module may reside in a storage medium (that is, the memory 1330 and/or the storage 1360) such as a RAM, a flash memory, a ROM, an EPROM, an EEPROM, a register, a hard disk, a removable disk, and a compact disk (CD)-ROM.

An exemplary storage medium may be coupled to the processor 1320, and the processor 1320 may read information from the storage medium and write information to the storage medium. For example, real-time hydrogen consumption data, sensor logs, and historical system performance metrics may be stored for analysis and optimization. In another manner, the storage medium may be formed integrally with the processor 1320. In such cases, embedded multi-chip packages (eMCPs) or system-in-package (SiP) solutions may be utilized to enhance data processing efficiency and reduce latency. The processor and the storage medium may reside inside an application-specific integrated circuit (ASIC). The ASIC may be tailored for specific tasks such as hydrogen fuel cell control, BOG management, or high-speed sensor data processing. The ASIC may also reside in an in-vehicle controller. In another manner, the processor 1320 and the storage medium may also reside as separate components within the vehicle controller. This modular architecture may allow flexibility in system upgrades, component replacements, and scalability for future advancements in fuel cell vehicle technology.

An aspect of the present disclosure provides a fuel supply system for a fuel cell system and a method of controlling the same.

Another aspect of the present disclosure also provides a liquid hydrogen-based fuel cell fuel supply system for increasing a hydrogen storage capacity and a method of controlling the same.

Still another aspect of the present disclosure also provides a fuel supply system for a fuel cell electric vehicle capable of increasing a hydrogen storage capacity by controlling a hydrogen compressor and a liquid hydrogen pump according to an amount of boil-off gas (BOG) generated in a hydrogen storage tank and capable of stable vehicle operation by controlling start-up according to the control result, and a method of controlling the same.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a fuel supply system for a fuel cell system includes a hydrogen compressor that compresses a boil-off gas (BOG) from a liquid hydrogen storage tank and generates compressed hydrogen, a hydrogen cooler that cools the compressed hydrogen and provides first hydrogen, and a liquid hydrogen vaporizer that vaporizes liquid hydrogen from the liquid hydrogen storage tank and provides second hydrogen, wherein at least one of the first hydrogen and the second hydrogen is supplied to the fuel cell system based on an amount of the BOG and an amount of required hydrogen of the fuel cell system.

As an example, the first hydrogen may be supplied to the fuel cell system based on the amount of the BOG, which is greater than the amount of the required hydrogen.

As an example, the first hydrogen and the second hydrogen may be supplied to the fuel cell system based on the amount of the BOG, which is smaller than the amount of the required hydrogen.

As an example, the fuel supply system may further include a liquid hydrogen pump that is provided inside or outside the liquid hydrogen storage tank and provides the liquid hydrogen to the liquid hydrogen vaporizer, wherein the liquid hydrogen pump may be driven based on the amount of the BOG, which is smaller than the amount of the required hydrogen.

As an example, the hydrogen compressor may perform compression control or flow rate control, and the compression control may be performed based on the amount of the BOG, which is greater than the amount of the required hydrogen, and the flow rate control may be performed based on the amount of the BOG, which is smaller than the amount of the required hydrogen.

As an example, the fuel supply system may further include a tank pressure regulator that discharges a pressure of the liquid hydrogen storage tank to an outside based on the amount of the BOG, which is greater than a predetermined reference value.

As an example, the fuel supply system may further include a flow rate controller that controls flow rates of the hydrogen and air supplied to the fuel cell system based on the amount of the required hydrogen.

As an example, the flow rate controller may include a hydrogen flow rate controller that controls the flow rate of the hydrogen supplied to the fuel cell system by adjusting a first valve based on a set point (SP) calculated based on the amount of the required hydrogen and a first processing variable acquired from a first flow rate element that measures the flow rate of the hydrogen supplied to the fuel supply system and an air flow rate controller that controls the flow rate of the air supplied to the fuel supply system by adjusting a second valve based on the SP and the first processing variable received from the hydrogen flow rate controller and a second processing variable acquired from a second flow rate element that measures the flow rate of the air supplied to the fuel cell system.

As an example, the air flow rate controller may select a larger value among the SP and the first processing variable and adjust the second valve based on the selected larger value and the second processing variable.

As an example, the hydrogen compressor may be implemented by arranging a plurality of compressors having the same type or different types in parallel or series.

According to another aspect of the present disclosure, a method of supplying a fuel for a fuel cell system includes compressing, by a hydrogen compressor, a boil-off gas (BOG) from a liquid hydrogen storage tank and generating compressed hydrogen, cooling, by a hydrogen cooler, the compressed hydrogen and generating first hydrogen, and vaporizing, by a liquid hydrogen vaporizer, liquid hydrogen from the liquid hydrogen storage tank and generating second hydrogen, wherein at least one of the first hydrogen and the second hydrogen is supplied to the fuel cell system based on an amount of the BOG and an amount of the required hydrogen of the fuel cell system.

As an example, the first hydrogen may be supplied to the fuel cell system based on the amount of the BOG, which is greater than the amount of the required hydrogen.

As an example, the first hydrogen and the second hydrogen may be supplied to the fuel cell system based on the amount of the BOG, which is smaller than the amount of the required hydrogen.

As an example, the method may further include driving a liquid hydrogen pump based on the amount of the BOG, which is smaller than the amount of the required hydrogen, wherein the liquid hydrogen stored in the liquid hydrogen storage tank may be provided to the liquid hydrogen vaporizer by the driven liquid hydrogen pump.

As an example, the hydrogen compressor may perform compression control or flow rate control, and the compression control may be performed based on the amount of the BOG, which is greater than the amount of the required hydrogen, and the flow rate control may be performed based on the amount of the BOG, which is smaller than the amount of the required hydrogen.

As an example, the method may further include discharging, by a tank pressure regulator, a pressure of the liquid hydrogen storage tank to an outside based on the amount of the BOG, which is greater than a predetermined reference value.

As an example, the method may further include controlling, by a flow rate controller, flow rates of the hydrogen and air supplied to the fuel cell system based on the amount of the required hydrogen.

As an example, the flow rate controller may include a hydrogen flow rate controller that controls the flow rate of the hydrogen supplied to the fuel supply system by adjusting a first valve based on a set point (SP) calculated based on the amount of the required hydrogen and a first processing variable acquired from a first flow rate element that measures the flow rate of the hydrogen supplied to the fuel supply system and an air flow rate controller that controls the flow rate of the air supplied to the fuel supply system by adjusting a second valve based on the SP and the first processing variable received from the hydrogen flow rate controller and a second processing variable acquired from a second flow rate element that measures the flow rate of the air supplied to the fuel cell system.

As an example, the air flow rate controller may select a larger value among the SP and the first processing variable and adjust the second valve based on the selected larger value and the second processing variable.

As an example, the hydrogen compressor may be implemented by arranging a plurality of compressors having the same type or different types in parallel or series.

The present disclosure provides a fuel supply system for a fuel cell system and a method of controlling the same.

Further, the present disclosure also provides a liquid hydrogen-based fuel cell fuel supply system for increasing a hydrogen storage capacity and a method of controlling the same.

Further, the present disclosure also provides a fuel supply system for a fuel cell electric vehicle capable of increasing a hydrogen storage capacity by controlling a hydrogen compressor and a liquid hydrogen pump according to an amount of boil-off gas (BOG) generated in a hydrogen storage tank and capable of stable vehicle operation by controlling start-up according to the control result, and a method of controlling the same.

In addition, various effects directly or indirectly identified though the present document may be provided.

The above description is merely illustrative of the technical spirit of the present disclosure, and those skilled in the art to which the present disclosure belongs may make various modifications and changes without departing from the essential features of the present disclosure.

Thus, the examples disclosed in the present disclosure are not intended to limit the technology spirit of the present disclosure, but are intended to describe the present disclosure, and the scope of the technical spirit of the present disclosure is not limited by these examples. The scope of protection of the present disclosure should be interpreted by the appended claims, and all technical spirits within the scope equivalent thereto should be interpreted as being included in the scope of the present disclosure.

What is claimed:

1. An apparatus comprising:
a hydrogen compressor configured to compress a boil-off gas (BOG) from a liquid hydrogen storage tank and generate compressed hydrogen;
a hydrogen cooler configured to cool the compressed hydrogen and provide a first portion of hydrogen; and
a liquid hydrogen vaporizer configured to vaporize liquid hydrogen from the liquid hydrogen storage tank and provide a second portion of hydrogen,
wherein at least one of the first portion of hydrogen or the second portion of hydrogen is supplied to a fuel cell system based on an amount of the BOG and an amount of hydrogen required by the fuel cell system.

2. The apparatus of claim 1, wherein the first portion of hydrogen is supplied to the fuel cell system based on a determination that the amount of the BOG is greater than the amount of hydrogen required by the fuel cell system.

3. The apparatus of claim 1, wherein the first portion of hydrogen and the second portion of hydrogen are supplied to the fuel cell system based on a determination that the amount of the BOG is smaller than the amount of hydrogen required by the fuel cell system.

4. The apparatus of claim 1, further comprising:
a liquid hydrogen pump provided inside or outside the liquid hydrogen storage tank and configured to provide the liquid hydrogen to the liquid hydrogen vaporizer,
wherein the liquid hydrogen pump is driven based on a determination that the amount of the BOG is smaller than the amount of hydrogen required by the fuel cell system.

5. The apparatus of claim 1, wherein the hydrogen compressor is configured to perform compression control or flow rate control, and
wherein the compression control is performed based on a determination that the amount of the BOG is greater than the amount of hydrogen required by the fuel cell system, and
wherein the flow rate control is performed based on a determination that the amount of the BOG is smaller than the amount of the hydrogen required by the fuel cell system.

6. The apparatus of claim 1, further comprising:
a tank pressure regulator configured to reduce a pressure of the liquid hydrogen storage tank by discharging at least a portion of the BOG to an outside based on a determination that the amount of the BOG is greater than a predetermined reference value.

7. The apparatus of claim 1, further comprising:
flow rate controller circuitry configured to control flow rates of hydrogen and air supplied to the fuel cell system based on the amount of hydrogen required by the fuel cell system.

8. The apparatus of claim 7, wherein the flow rate control circuitry comprise:
a hydrogen flow rate controller circuit configured to control the flow rate of the hydrogen supplied to the fuel cell system by adjusting a first valve based on a set point (SP)and a first processing variable, wherein the SP is determined based on the amount of hydrogen required by the fuel cell system, and wherein the first processing variable is acquired from a first flow rate measurement circuit configured to measure the flow rate of the hydrogen supplied to the apparatus; and
an air flow rate controller circuit configured to control the flow rate of the air supplied to the fuel cell system by adjusting a second valve based on the SP, the first processing variable, and a second processing variable, wherein the second processing variable is acquired from a second flow rate measurement circuit configured to measure the flow rate of the air supplied to the fuel cell system.

9. The apparatus of claim 8, wherein the air flow rate controller circuit is configured to:
select a larger value of the SP and the first processing variable, and
adjust the second valve based on the selected larger value and the second processing variable.

10. The apparatus of claim 1, wherein the hydrogen compressor comprises a plurality of compressors having a same type or different types of compressors arranged in parallel or series.

11. A method performed by an apparatus comprising:
compressing, by a hydrogen compressor, a boil-off gas (BOG) from a liquid hydrogen storage tank of the apparatus and generating compressed hydrogen;
cooling, by a hydrogen cooler of the apparatus, the compressed hydrogen and generating a first portion of hydrogen; and
vaporizing, by a liquid hydrogen vaporizer of the apparatus, liquid hydrogen from the liquid hydrogen storage tank and generating a second portion of hydrogen,
wherein at least one of the first portion of hydrogen or the second portion of hydrogen is supplied to a fuel cell system based on an amount of the BOG and an amount of hydrogen required by the fuel cell system.

12. The method of claim 11, further comprising:
supplying the first portion of hydrogen to the fuel cell system based on a determination that the amount of the BOG is greater than the amount of hydrogen required by the fuel cell system.

13. The method of claim 11, further comprising:
supplying the first portion of hydrogen and the second portion of hydrogen to the fuel cell system based on a determination that the amount of the BOG is smaller than the amount of hydrogen required by the fuel cell system.

14. The method of claim 11, further comprising:
driving a liquid hydrogen pump based on a determination that the amount of the BOG is smaller than the amount of hydrogen required by the fuel cell system,
wherein the liquid hydrogen from the liquid hydrogen storage tank is provided to the liquid hydrogen vaporizer by the driving the liquid hydrogen pump.

15. The method of claim 11, wherein the compressing the BOG comprises:
performing a compression control based on a determination that the amount of the BOG is greater than the amount of hydrogen required by the fuel cell system, and
performing a flow rate control based on a determination that the amount of the BOG is smaller than the amount of hydrogen required by the fuel cell system.

16. The method of claim 11, further comprising:
reducing, by a tank pressure regulator of the apparatus, a pressure of the liquid hydrogen storage tank by discharging at least a portion of the BOG to an outside based on a determination that the amount of the BOG is greater than a predetermined reference value.

17. The method of claim 11, further comprising:
controlling, by flow rate controller circuitry of the apparatus, flow rates of hydrogen and air supplied to the fuel cell system based on the amount of hydrogen required by the fuel cell system.

18. The method of claim 17, wherein the controlling the flow rates of hydrogen and air comprises:
controlling, by a hydrogen flow rate controller circuit of the flow rate controller circuitry, the flow rate of the hydrogen supplied to the fuel cell system by adjusting a first valve based on a set point (SP) and a first processing variable, wherein the SP is determined based on the amount of hydrogen required by the fuel cell system, and wherein the first processing variable is acquired from a first flow rate measurement circuit configured to measure the flow rate of the hydrogen supplied to the apparatus; and
controlling, by an air flow rate controller circuit of the flow rate controller circuitry, the flow rate of the air supplied to the fuel cell system by adjusting a second valve based on the SP, the first processing variable, and a second processing variable, wherein the second processing variable is acquired from a second flow rate measurement circuit configured to measure the flow rate of the air supplied to the fuel cell system.

19. The method of claim 18, further comprising:
selecting, by the air flow rate controller circuit, a larger value of the SP and the first processing variable; and
adjusting the second valve based on the selected larger value and the second processing variable.

20. An apparatus comprising:
a processor; and
a memory storing at least one instruction that, when executed by the processor communicating with the memory, is configured to cause the apparatus to:
compress, using a compressor, a boil-off gas (BOG) from a liquid hydrogen storage tank and generate compressed hydrogen;
cool, using a cooler, the compressed hydrogen and provide a first portion of hydrogen;
vaporize, using a vaporizer, liquid hydrogen from the liquid hydrogen storage tank and provide a second portion of hydrogen; and
control, based on an amount of the BOG and an amount of hydrogen required by a fuel cell system, output of at least one of the first portion of hydrogen or the second portion of hydrogen.
